(19) United States
(12) Patent Application Publication
(10) Pub. No.: US 2011/0188413 A1
(43) Pub. Date: Aug. 4, 2011

(54) WIRELESS REPEATER DEVICE, METHOD AND SYSTEM FOR IMPLEMENTING CONTROL OF THE SAME IN A WIRELESS NETWORK SYSTEM

(75) Inventors: WEN-YI KUO, TAIPEI CITY (TW); YUEH-FENG LEE, TAIPEI COUNTY (TW); TZONG-CHUNG WANG, TAIPEI COUNTY (TW); TUNG-YI LEE, TAIPEI COUNTY (TW)

(73) Assignee: BANDRICH, INC., TAIPEI COUNTY (TW)

(21) Appl. No.: 12/975,637

(22) Filed: Dec. 22, 2010

Related U.S. Application Data
(60) Provisional application No. 61/301,002, filed on Feb. 3, 2010.

(51) Int. Cl. H04B 7/14

(52) U.S. Cl. 370/279

(57) ABSTRACT

The invention relates to a wireless repeater device, a method and a system for implementing control of the device remotely over a wireless network. It is featured that the wireless repeater device is able to be configured by a direct control mode, an on-site mode and a remote control mode. Through the claimed system, a remote operator may access the wireless repeater device over a wireless network. The wireless repeater device particularly has a control modem circuit which is enabled by a mobile identification scheme, and the configuration can be performed over a mobile communication network. The signals carried with the control parameters from an operator end may be delivered in the form of SMS messages.

### CROSS REFERENCE TO RELATED APPLICATIONS

This application claims the benefit under 35 U.S.C. 119(e) of U.S. Provisional Application No. 61/301,002, filed Feb. 3, 2010, the disclosure of which is incorporated by reference herein in its entirety.

### BACKGROUND OF THE INVENTION

1. Field of the Invention

The invention relates to a wireless repeater device, a method, and system for implementing control of the same in a wireless network system. More particularly, the invention relates to a wireless repeater device adapted in a wireless network system, and a remote controlling method for one or more wireless repeater devices.

2. Description of Related Art

The rapid growth of the supported wireless transmission data rate by cellular communication systems is accompanied by a strong demand and need for better quality of electromagnetic energy of radio reception. However, home and office users usually suffer from less indoor coverage and hence usually experience low data transmission. It is inevitable that network service providers will continue to install more wireless repeaters before providing, delivering and servicing what they claim to support.

Traditional wireless repeaters are built based on pure RF (radio frequency) components. Such RF components are of industrial-grade and are usually customized for special requirements. This means high BOM (Bill of Materials) costs are imposed on network service providers and make their mass-deployment nearly impossible.

On the other hand, traditional repeaters are usually fixed in their configurations such as frequency range and power gain level. This creates still further difficulties for network service providers configuring and maintaining their wireless repeaters as most of them are installed in indoor environments.

The basic intent for a conventional repeater, to which reference is made in FIG. 1, is to extend the broadcast and reception throughout the repeater network. FIG. 1 shows a series of repeaters 101, 102, 103 disposed on the line from a terminal station 11 to a base station 12 at another end. That means that each repeater may extend the signal transmitted from its adjacent device or repeater. In an example, the terminal station 11 may establish a wireless connection with the base station 12. Since the wireless signals may weaken with a long distance delivery, some number of repeaters disposed along the route are usually necessary.

A significant aspect in these systems is that each repeater requires maintenance. To maintain a repeater, an operator must go to the machine and perform maintenance through a wired connection between the repeater and a computer, using, for example, a COM port.

If an operator needs to maintain many repeaters in a wide wireless or wired network system, significant time must be expended to accomplish such maintenance. For these reasons, there is clear need for a new device, preferably which is all of cost-effective, able to be analyzed and controllable by remote means and method adapted to enhance wireless network systems requiring one or more repeaters which are both cost-efficient and remote-controllable.

### SUMMARY OF THE INVENTION

It is an object of the invention to provide one or more solutions for at least the problems in the conventional technology. With this invention, network service providers can easily mass-deploy and configure network devices, particularly the repeaters.

A wireless repeater device capable of being remote controlled adapted to serve in a wireless network system is provided. The wireless repeater device at least includes a repeater circuit and a control modem circuit. The repeater circuit is used to extend or amplify a designated frequency range. Via the control modem circuit, the remote operator may perform the configuration of the frequency range. Primarily, and particularly, the repeater circuit will have at least has two duplexers, two RF transceivers, a splitter, a combiner, and two independent antennas. The control modem circuit may be an external module plugged into the repeater circuit, or an internal circuit. Preferably, a baseband controller, an RF transceiver, a display, a keypad, and a USB-enabled port are included in the control modem circuit.

A system for implementing remotely control of the one or more wireless repeater devices at least includes the wireless repeater device capable of networking and the operator PC. Particularly the wireless repeater device has a repeater circuit used for extending communication signals and a control modem circuit for providing the wireless repeater device to connect with a network. Preferably, the wireless repeater device can be accessed through the control modem circuit over a mobile communication network. Therefore, the signals generated from the operator PC may be transformed to SMS messages in compliance with standards of over-the-mobile-network communications.

According to one of the embodiments, the system may further include a server with a wireless modem and the operator device. Since the operator device is only capable of connecting with the packet-switched data network, the operator should access the wireless repeater device enabled via SIM (Subscriber Identity Module) technology through the server. Over the mobile communication network, the signals are firstly interpreted in the server, and sent out to the wireless repeater device. The signals forwarded over the mobile communication network are preferably in the form of SMS-standard messages.

Furthermore, the invention provides a method for implementing control of the wireless repeater device, especially over a network. However, the operator may go directly to the device and perform the configuration of the device by a direct control mode or an on-site mode.

According to the preferred embodiment, an initial step in the method is to initialize the wireless repeater device. Signals may be transferred via a control modem circuit of the wireless repeater device. After that, a baseband controller in the control modem circuit performs configuration based on the signals to the wireless repeater device. The signals are preferably transmitted over a mobile communication network, and the signals are in the form of SMS messages.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of a series of conventional repeaters disposed between the stations;

FIG. 2 shows a schematic diagram of an embodiment of a wireless repeater according to the invention;

FIG. 3 draws a schematic diagram of a network framework for implementing remotely control of a wireless repeater device in accordance with the invention;

FIG. 4 shows functional blocks of a wireless repeater device in accordance with the invention;

FIG. 5 is a flow chart of performing configuration using the keypad and the display on the wireless repeater device;

FIG. 6 is a flow chart of performing configuration using PC tools connected to the wireless repeater device through USB;

FIG. 7 is a flow chart of performing configuration via SMS or packet-switched data connections.

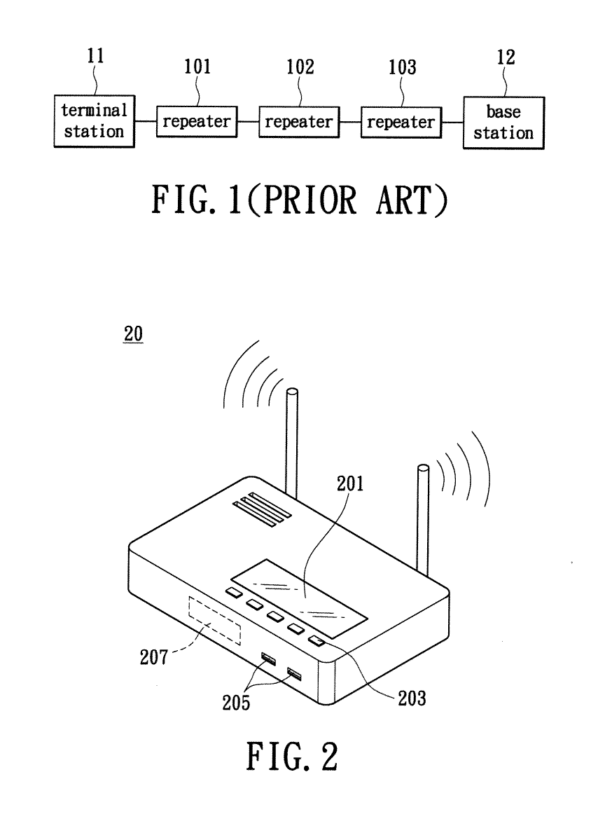

### DETAILED DESCRIPTION OF THE PREFERRED EMBODIMENTS

While the invention will be described more fully hereinafter with reference to the accompanying drawings, in which a preferred embodiment(s) of the invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the invention.

In some cases, a wireless network provider may install one or more repeaters in order to improve service in a region lying on an edge of the coverage area serviced by a base station. Thereby the coverage can be effectively extended for the base-station. However, in view of the most conventional repeaters lack of effective solution for remote control, the invention particularly provides wireless repeater device capable of being remote controlled. A method for conducting the control on the device over a wireless network system is also provided.

Reference is made to FIG. 2, which shows a schematic diagram of an embodiment of a wireless repeater according to the invention. The outward appearance of this repeater 20 preferably includes one or two antennas, a LCD screen 201 on the panel, a set of keypad 203 thereon, and one or more industrial standards of connection ports 205, such as RS-232 and USB (Universal Serial Bus). In practice, the invention is not limited to the wireless repeater, but also to the wired repeater.

According to a preferred embodiment, a control modem 207 for implementing remote control is particularly provided. The repeater 20 primarily has a repeater circuit which functions receiving signals and retransmitting them in order to extend the signaling coverage, and the control modem 207. More particularly, the control modem 207 may be a communication module built in the repeater 20, however, the control modem 207 may also be an external module plugged into the repeater 20.

One major objective of the invention is to perform a remote control on the wireless repeater device through the control modem 207, especially over the mobile communication network. Preferably, the control modem circuit is capable of mobile network connection since it is enabled via a SIM (subscriber identity module) card. A remote operator or any user who have privilege to access the repeater 20 may perform the remote control through the control modem 207.

The invention provides some preferable approaches to implement the maintenance on the repeater 20. Followings are the claimed approaches based on the design of repeater 20:

Direct Control Mode:

One of the approaches is to perform a direct control through a set of keypad (203). The set of keypad (203) is disposed on the panel of the repeater (20), and especially the control signals generated by the keypad (203) are associated with the control modem. The operator may perform configuration of the repeater (20) by keying in the command with the keypad. Some related instructions and response may be displayed on screen (201). It is very convenient for the operator to control and check the status of the device directly from the screen (201) thereon.

On-Site Control Mode:

The claimed repeater (20) provides one or more connection ports (205), especially the USB connection or the like. Therefore, the operator may utilize a laptop or any computer system to link the control modem (207) via one of the connection ports (205), and perform any configuration. The generated control signals can be transmitted via the connection port (205).

Remote Control Mode 1:

The remote operators may send various control parameters to the repeater (20) wirelessly. More particularly, the control modem (207) is in compliance with one or more protocols configured to the mobile communication connections. A remote operator may remotely perform a remote control over a mobile network via a SMS since the control modem (207) is enabled by a mobile identification scheme, preferably via a SIM card, and capable of mobile network connection. The SMS message of the short-message service may carry with the control parameters in compliance with a specific format. In practice, the operator may send the SMS message directed to the control modem (207) over the mobile network. While the control modem (207) receives the SMS message carried with the control parameters, a decode routine will be enabled to perform the control parameters and conduct the configuration. After that, according to the commands represented by the control parameters, the control modem (207), in a feature, may respond status information, such as repeater frequency and bandwidth, repeater power gain level, status report content and period, control modem radio technology, SMSC, etc. Particularly, the status information may be sent back to the operator by the SMS messages.

Remote Control Mode 2:

The remote operator may also perform configuration or monitoring on the repeater (20) via a packet-switched data connection. Preferably, the remote operator uses a terminal computer system to access the repeater (20) through the control modem (207). According to one of the preferred embodiments, since the control modem (207) may merely provide the mobile communication connection, the packet-switched data may be delivered over the data-switched network and forwarded to mobile communication network. According to another preferred embodiment, since the control modem (207) provides wired connection to external, the remote operator may access the device via DSL or cable connection. After the connection between the remote computer system and the control modem (207) is established, the remote operator may send the control parameters to the repeater (20) wirelessly. One of the main purposes of the remote control is to check the status information or to perform the configuration on the device. In addition to the above-mentioned preferable information, the mentioned control parameters may also carry the instructions of detecting a sufficient strong outdoor radio signals or shutting down the repeater radio to save power for reducing signaling interference.

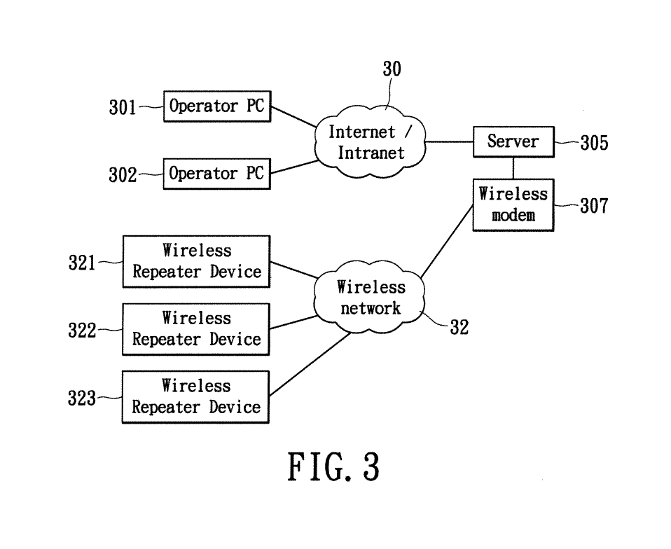

For implementing remote control of the one or more wireless repeater devices, according to the instant disclosure, the operator end may use any device capable of connecting the network, preferably the mobile communication network, to access the wireless repeater device. Reference is made to FIG. 3, which draws a schematic diagram of a network framework for implementing the method for remotely controlling the wireless repeater device in accordance with the invention.

The network framework preferably includes a server 305, a wireless modem 307, one or more operator PCs 301, 302, and a plurality of wireless repeater devices 321, 322, 323. The server 305 actually functions as a gateway which is equipped with the wireless modem 307, and the operator(s) may access to the remote wireless repeater device(s) by passing the server 305. According to the invention, the remote operators firstly use the operator PCs to access the server 305 via Internet or Intranet (30), preferably over a packet-switched data network. The server 305 is used to transfer control parameters to the wireless repeater devices 321, 322, 323 and store the status information of each wireless repeater device 321, 322 or 323. In particular, the wireless modem 307 disposed to the server 305 is provided for the control parameters or any access signal transferred to those wireless repeater devices 321, 322, 323 over a wireless network 32.

According to the preferred embodiment, the above mentioned wireless network 32 is actually a mobile communication network. Preferably the remote operator(s) may access those wireless repeater devices 321, 322, 323 by sending the control parameters in the form of SMS message. However, the wireless modem 307 may merely provide the mobile communication connection, so that the packet-switched data generated by the operator PCs 301, 302 may be delivered over the data-switched network (Internet/Intranet 30) and forwarded to the mobile communication network (wireless network 32).

In another embodiment, since the operator device is capable of connecting with the mobile communication, the operator may directly access the wireless repeater device enabled by a mobile identification scheme, preferably via a SIM card, over the mobile communication network. Preferably, the SMS message is used for the remote configuration.

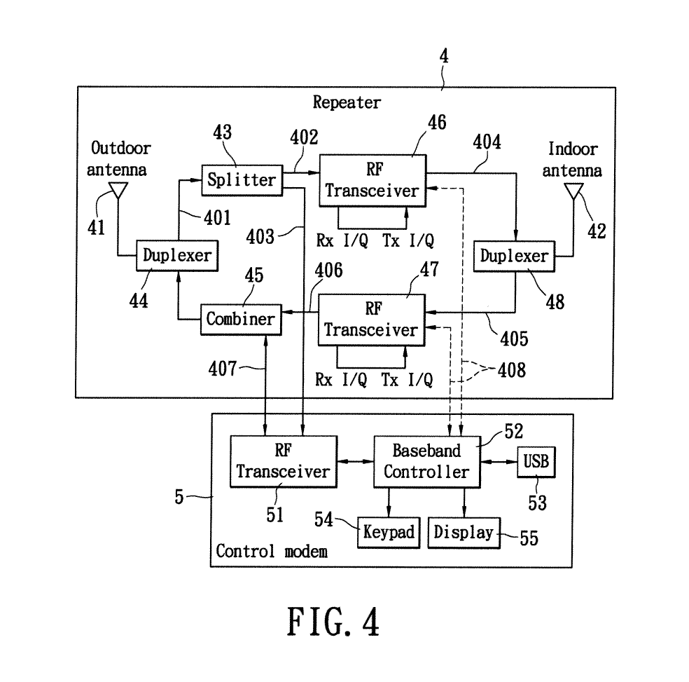

Further refer to FIG. 4, which shows functional blocks of the wireless repeater device in accordance with the invention. Particularly, the wireless repeater device primarily has two portions of circuits including a repeater circuit 4 and a control modem circuit 5. It is featured that the control modem circuit 5 is provided for the repeater circuit 4 to conduct the remote control via wired or wireless connection. Preferably, the repeater circuit 4 has two independent antennas, including an outdoor antenna 41 and an indoor antenna 42, which are respectively functioned for transmitting the outdoor and indoor signals. In practice, the outdoor antenna 41 and the indoor antenna 42 in one repeater circuit 4 may be designed as one element which is in charge of transmitting the In/out signals. The duplexers 44 or 48 of the repeater circuit 4 is a circuit that serves a bi-directional (duplex) communication, especially the duplexers 44 and 48 are correspondingly connected with the two antennas 41 and 42.

Further, the repeater circuit 4 also has two RF transceivers 46, 47, in which the first RF transceiver 46 is installed for downlink signal path and the second RF transceiver 47 is for uplink signal path in order to process the RX/TX signals. That means that the two RF transceivers are used to down-convert and up-convert radio signals. The two RF transceivers 46, 47 preferably directly loops their receive IQ output signals back to their transmit IQ input signals, that means the inside receive I and Q outputs of the individual RF transceiver are looped back to its transmit I and Q inputs, respectively. Through the control modem circuit 5, the I and Q status may be sent to the operator.

The repeater circuit 4 further has a splitter 43 connected with the duplexer 44 and the RF transceiver 46. The splitter 43 is for splitting the signals from the outdoor antenna 41 into two routes for delivering the signals to indoor side and the control modem circuit 5 respectively. The repeater circuit 4 has a combiner 45 which is connected with the other one duplexer 44 and used for combining the signals from the RF transceiver 47 on the indoor side and the RF transceiver 51 of the control modem circuit 5.

The control modem circuit 5 particularly includes an RF transceiver 51, a baseband controller 52. Further, the control modem circuit 5 has a display module 55, a keypad module 54, and a connection port module 53, preferably a USB. The display module 55, keypad module 54 and connection port module 53 are electrically connected with the baseband controller 52.

The repeater circuit 4 is used to extend and amplify a designated frequency range, which can be controlled through the control modem circuit 5. The control modem circuit 5 is particularly provided for the remote operator to perform a remote control on this wireless repeater device. The remote operator may perform any configuration and monitor the status of the repeater device. According to the embodiment, the repeater circuit 4 and the control modem circuit 5 may preferably share the outdoor antenna 41. Over the outdoor antenna 41, this wireless repeater device is enabled to receive and transmit both the signal as a specific frequency band and the control signal over a certain mobile communication network.

As to downlink signals, after receiving the signals (outdoor side), the splitter 43 splits the signals from the duplexer 44 (over connection 401) and directs to both the first RF transceiver 46 (over connection 402) and the RF transceiver 51 of control modem circuit 5 (over connection 403). The signals from the first RF transceiver 46 then progress toward to the indoor antenna 42 over connection 404 through the duplexer 48.

As to uplink signal, the signals received from the indoor antenna 42 progress toward the second RF transceiver 47 over connection 405 through the duplexer 48. After the signal processing, the signals are delivered over connection 406 to the combiner 45, and to the outdoor antenna 41 through the duplexer 44.

In accordance with the invention, the claimed control modem circuit 5 may be an external module plugged into the repeater circuit 4, or alternatively be an internal circuit of the repeater-able circuit 4. Particularly, the control modem circuit 5 includes the aforementioned display module 55, keypad module 54, and connection port module 53, which is preferably with a short-range transmission technology, such as USB, Bluetooth, UART, or IrDA.

Refer to FIG. 4, the control modem circuit 5 is electrically connected with the repeater circuit 4 via several connections. Since the downlink signals pass through the splitter 43, the splitter 43 directs the signals, especially the signals carried with the control parameters, to the RF transceiver 51 of the control modem circuit 5 over connection 403. The signals with the control parameters are preferably sent from the remote operator. Those control parameters relate to repeater frequency and bandwidth, repeater power gain level, status report content and period, control modem radio technology, or SMSC. After that, the baseband controller 52 of the control modem circuit 5 takes over the signals and performs decoding since they may be in the form of SMS message or other format in compliance with a predefined standard. It is worth noting that the baseband controller 52 is also able to receive the control parameters from the shown USB-enabled port 53 or keypad 54.

The baseband controller 52 electrically connected with the RF transceiver 51 is also electrically connected with the RF transceivers 46 and 47, and is capable of retrieving information from them over connections 408. The connections 408 are bi-directional for communicating between the repeater circuit 4 and the control modem circuit 5. Via the communication, the remote operator may retrieve the information, preferably the repeater status information, along both downlink and uplink streams through the control modem circuit 5.

In practice, the control modem circuit 5 can be enabled via a SIM card. Via the control modem circuit 5, the remote operator accesses the wireless repeater device over a network, for example the mobile communication network. The control parameters sent from the remote operator are conducted to configure the wireless repeater device, such as to configure the frequency and bandwidth for the repeater, or to adjust the power gain level, or to switch the radio on or off. Furthermore, the remote operator may retrieve the status information related to the frequency and bandwidth, power gain level, and radio on or off. The status information for the control modem circuit includes the information of radio technology, PLMN, RSSI, pilot Ec/Io, RSCP, PSC, CQI, UARFCN, and BSIC, which may also be retrieved via any possible radio technology, or a SMSC (Short Message Service Center).

Based on the control parameters, the wireless repeater device can be commanded to search for supported radio frequencies, radio technology, PLMN IDs, and to deliver a list of the above information to the remote operator(s). When any failure to any one of the wireless repeater devices to be monitored is detected, the wireless repeater device will send an alarm message to the remote operator(s) via the control modem circuit 5. According to the preferred embodiment, the alarm message can be an alarm SMS message since both control module circuit and the operator(s) are provided with one or more pre-defined phone numbers, preferably attached with SIM card or any ID-recognizable scheme.

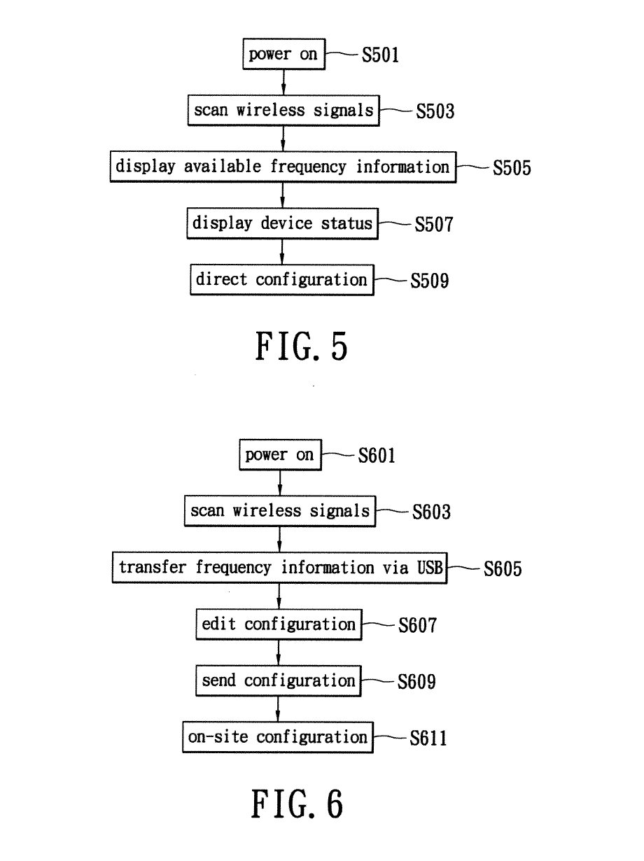

Reference is made to FIG. 5.

FIG. 5 illustrates a flow chart of a control method via a man-machine interface (using display and keypad) of the wireless repeater device. When the wireless repeater device is powered on (step S501), it is initialized. Then the wireless repeater device optionally scans existing wireless signals (step S503). After that, the screen may display a list of available frequency information (step S505). Further, the status of the device is also displayed (step S507). Then the user or operator performs a direct configuration of the device using keypad on the device (step S509).

In addition to the direct configuration illustrated in FIG. 5, FIG. 6 shows one more approach to implement an on-site configuration.

The operator goes directly to the device and uses a cable to link a PC with the wireless repeater device via USB at the moment before or after powering on the device. While the wireless repeater device is powered on and going through an initialization process (Step S601), the wireless repeater device optionally scans existing wireless signals (step S603). The operator may check the information delivered from the control modem on the screen of PC. The information including a list of available frequency information is transmitted to the PC via USB (step S605). Further, the status of the device is also delivered. Then the user or operator can edit the configuration of the repeater and control modem using some PC software tools especially for the claimed wireless repeater device (step S607). Since the configuration is finished on the PC, the configuration is sent back to the wireless repeater device through USB or any the other available port (step S609). Then the on-site configuration is done as reconfiguring the device (step S611).

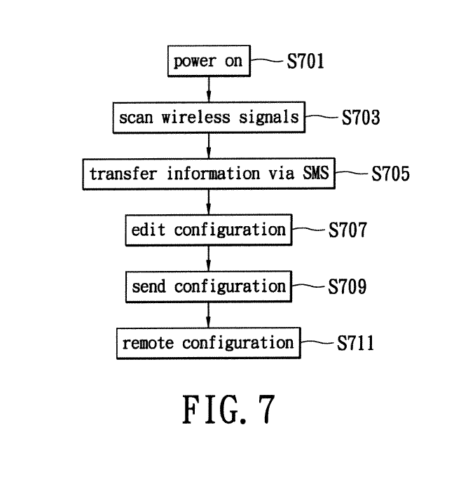

Reference is made to FIG. 7.

FIG. 7 illustrates a flow chart of one more control method via wired and wireless network connection. In the beginning, the wireless repeater device is powered on (step S701), and initialized. Then the device optionally scans existing wireless signals (step S703). The wireless signal scanning will search the defined frequency band which the repeater operates on, and also the electromagnetic frequency applicable to the mobile communication for the remote control. After that, a list of available frequency information may be delivered to the operator PC via SMS or packet-switched data connection (step S705). Further, the status of the device is also delivered. On the operator's side, the operator PC may have some software tools especially for the wireless repeater device installed. The user or operator may edit the configuration of the repeater and control modem using the tools (step S707). After the configuration is done on the operator PC, the configuration is sent back to the wireless repeater device over the mobile communication network or the packet-switched data network (step S709). The sent configuration is preferably in the form of SMS message as over the mobile communication network. Alternatively, the configuration may also be encoded as the form of the network packet as over the packet-switched data connection. When the control modem receives the SMS message or the packet, it will reconfigure the device (step S711).

It is worth noting that the control modem associated with the wireless repeater device may support one or more of GPRS, EDGE, WCDMA, HSDPA, HSUPA, HSPA+, LTE, CDMA2000, or WiFi in accordance with the invention. Furthermore,

To sum up, one of the objectives of the invention is to provide a wireless network system with one or more wireless repeater devices, and the remote operator may remotely access the wireless repeater device over the wireless network, especially the mobile communication network. It provides a very convenient way to perform the maintenance on the wireless repeater devices. More particularly, the configuration-related control parameters can be delivered using the form of SMS message over the mobile communication network. Through the SMS, the remote operator may easily control and monitor the each repeater by transmitting the SMS message. However, the claimed repeater further provides the direct control mode and on-site mode for the various purposes.

The above-mentioned descriptions represent merely the preferred embodiment of the invention, without any intention to limit the scope of the invention thereto. Various equivalent changes, alternations or modifications based on the claims of invention are all consequently viewed as being embraced by the scope of the invention.

What is claimed is:

1. A wireless repeater device capable of being remote controlled, comprising:
(a) a repeater circuit, comprising:
(i) one or more antennas;
(ii) one or more duplexers correspondingly connected with the one or more antennas and allowing bi-directional communication over a single channel;
(iii) one or more RF transceivers, in which a first of the RF transceivers is installed for downlink signal path and a second of the RF transceivers is installed for uplink signal path of the repeater circuit;
(iv) a splitter connected with one of the duplexers and the first of the RF transceivers for splitting signals from the one duplexer into two routes;
(v) a combiner connected with the one of the duplexers and the second of the RF transceivers for combining signals;
(b) a control modem circuit electrically connected with the repeater circuit, comprising:
(i) an RF transceiver receiving the signals split from the splitter; and
(ii) a baseband controller electrically connected with the RF transceiver, and the one or more RF transceivers of the repeater circuit;
wherein, the wireless repeater device is accessed through the control modem circuit over a wireless network since the RF transceiver of the control modem circuit shares one of the antennas.

2. The device of claim 1, wherein the antennas includes one outdoor antenna and one indoor antenna.

3. The device of claim 2, wherein the splitter splits the signals from the connected duplexer toward the indoor antenna and to the RF transceiver of the control modem circuit.

4. The device of claim 2, wherein the combiner combines the signals from one of the RF transceivers of the repeater circuit and the signals from the control modem circuit.

5. The device of claim 1, wherein each RF transceiver directly loops receive I and Q output signals back to the RF transceiver's transmit I and Q input signals.

6. The device of claim 1, wherein the signals split from the splitter to the RF transceiver in the control modem circuit carry with control parameters.

7. The device of claim 6, wherein the control parameters conducted to configure the wireless repeater device include the configurations of frequency, bandwidth, power gain level and radio on or off.

8. The device of claim 6, wherein the control parameters relate to repeater frequency and bandwidth, repeater power gain level, status report content and period, control modem radio technology, or SMSC.

9. The device of claim 6, wherein status information related to the control modem circuit includes:
frequency, bandwidth, power gain level, radio on or off related to the wireless repeater device; and
the information of radio technology, PLMN, RSSI, pilot Ec/Io, RSCP, PSC, CQI, UARFCN, and BSIC related to the control modem circuit.

10. The device of claim 1, wherein the wireless repeater device is accessed through the control modem circuit over a mobile communication network, and the signals delivered over the mobile communication network are in the form of SMS message.

11. The device of claim 10, wherein the control modem circuit is enabled via a SIM card.

12. The device of claim 1, wherein the wireless repeater device is accessed through the control modem over a data-switched network, or using SMS message over a mobile communication network.

13. The device of claim 12, wherein the signals delivered over the data-switched network generated from one or more computers.

14. The device of claim 1, wherein the control modem circuit includes a display module, a keypad module, and a connection port module, which are electrically connected with the baseband controller.

15. A system for implementing remotely control of one or more wireless repeater devices, comprising:
(a) one or more wireless repeater devices capable of networking, wherein each device includes:
(i) a repeater circuit used for extending communication signals; and
(ii) a control modem circuit electrically connected with the repeater circuit, wherein the control modem is used for providing the wireless repeater device to connect with a network;
(b) an operation means for communicating with the wireless repeater device over the network.

16. The system of claim 15, wherein the wireless repeater device is accessed through the control modem circuit over a mobile communication network, and the signals delivered from the operation means over the mobile communication network are in the form of SMS message.

17. The system of claim 15, further comprising:
a server with a wireless modem, wherein the server functions as a gateway for the operation means accessing the wireless repeater device.

18. The system of claim 17, wherein the operation means transfers signals to the server over a packet-switched data network, and the server forwards the signals to the wireless repeater device over a mobile communication network.

19. A method for implementing control of the wireless repeater device recited as claim 1, comprising:
initializing a wireless repeater device;
receiving signals via a control modem circuit of the wireless repeater device over a mobile communication network; and
performing a configuration of the wireless repeater device;
wherein the wireless repeater device is able to be configured by a direct control mode, an on-site mode and a remote control mode.

20. The method of claim 19, wherein when a failure to the wireless repeater device is detected, the wireless repeater device sends an alarm SMS message to one or more pre-defined phone numbers via the control modem circuit.
